(19) United States
(12) Patent Application Publication
(10) Pub. No.: US 2012/0062118 A1
(43) Pub. Date: Mar. 15, 2012

(54) DISCHARGE APPARATUS

(75) Inventors: Shinjirou Seto, Hikone (JP); Akihide Sugawa, Hikone (JP)

(73) Assignee: Panasonic Electric Works Co., LTD., Osaka (JP)

(21) Appl. No.: 13/321,105

(22) PCT Filed: Jun. 22, 2010
(86) PCT No.: PCT/JP2010/060934

§ 371 Date: Nov. 17, 2011

(30) Foreign Application Priority Data
Jun. 26, 2009 (JP) 2009-152709

(51) Int. Cl. H01J 27/00

(52) U.S. Cl. 315/111.81

(57) ABSTRACT

A discharge apparatus (1) including a discharge electrode used to generate charged water microparticles or ions. A discharge passage (5) discharges the charged water microparticles or ions into a discharge target zone (3). The discharge passage (5) includes an upstream end (5a) that draws in the charged water microparticles or ions. Two or more branching passages (6) located downstream of the upstream end (5a) each have a discharge port (4) in communication with the discharge target zone (3).

### TECHNICAL FIELD

The present invention relates to a discharge apparatus.

### BACKGROUND ART

Prior art examples of a discharge apparatus include an electrostatic atomization apparatus, which generates charged water microparticles by applying high voltage to a discharge electrode, and an ion generation apparatus, which generates ions by applying high voltage to a discharge electrode.

Japanese Laid-Open Patent Publication No. 2008-155915 describes a prior art example of an electrostatic atomization apparatus. The electrostatic atomization apparatus of the publication is installed in the passenger compartment ceiling of an automobile. Further, the electrostatic atomization apparatus generates charged water microparticles, which are discharged into the passenger compartment from a discharge port. The charged water microparticles include radicals such as superoxide radicals and hydroxy radicals. Such radicals deodorize and sterilize the passenger compartment and inactivate allergen substances. This makes the passenger compartment comfortable.

The electrostatic atomization apparatus applies high voltage to water, which is supplied to a discharge electrode, and generates charged water microparticles of nanometer size. Ozone is also generated at the same time and discharged into the passenger compartment from the discharge port.

When installing the electrostatic atomization apparatus in the passenger compartment ceiling of an automobile as described in the above publication, a passenger's head would be located near the discharge port of the electrostatic atomization apparatus. Accordingly, the odor of the ozone discharged into the zone near the discharge port may be unpleasant to the passenger.

The electrostatic atomization apparatus may generate more charged water microparticles to effectively perform deodorization, sterilization, and allergen substance deactivation with the nanometer size charged water microparticles. However, this would also increase the amount of ozone that is generated at the same time and thus increase the ozone concentration at the vicinity of the discharge port. As a result, the ozone odor in the vicinity of the discharge port may become further unpleasant to the passenger.

Further, when using an ion generation apparatus to discharge ions into the passenger compartment, ozone is generated simultaneously with ions and discharged together with the ions from a discharge port. Accordingly, in the same manner as an electrostatic atomization apparatus, the odor of ozone in the vicinity of the discharge port may be unpleasant to the passenger.

### DISCLOSURE OF THE INVENTION

The present invention provides a discharge apparatus having a simple structure that suppresses ozone odor in the vicinity of the discharge port without decreasing the generated amount of charged water microparticles or ions.

One aspect of the present invention is a discharge apparatus including a discharge electrode used to generate charged water microparticles or ions. A discharge passage discharges the charged water microparticles or ions into a discharge target zone. The discharge passage includes an upstream end that draws in the charged water microparticles or ions. Two or more branching passages are each located downstream of the upstream end and have a discharge port in communication with the discharge target zone.

In the discharge apparatus, it is preferable that the opening area of all of the discharge ports totals to be greater than the flow passage area of the upstream end.

In the discharge apparatus, it is preferable that the opening area of each discharge port is greater than the flow passage area of the upstream end.

Preferably, the discharge apparatus further includes a blower that generates a current of air and discharges the charged water microparticles or ions with the current of air from the discharge ports into the discharge target zone.

Preferably, the discharge apparatus further includes a variable flow rate ratio unit arranged in a branching portion of the discharge passage to vary the ratio of the flow rate between the branching passages.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a discharge apparatus embodied in an electrostatic atomization apparatus;

FIG. 2 is a schematic diagram of an electrostatic atomization module arranged in the electrostatic atomization apparatus of FIG. 1;

FIG. 3 is a perspective view showing the structure of another branching passage;

FIG. 4 is a perspective view showing the structure of another air outlet;

FIG. 5 is a cross-sectional view showing the structure of a variable flow rate ratio unit arranged in a branching portion of a discharge passage; and

FIG. 6 is a cross-sectional view showing one example of an arrangement of the electrostatic atomization apparatus or ion generation apparatus in the passenger compartment.

### DESCRIPTION OF EMBODIMENTS

A discharge apparatus 1 according to one embodiment of the present invention will now be discussed with reference to the drawings.

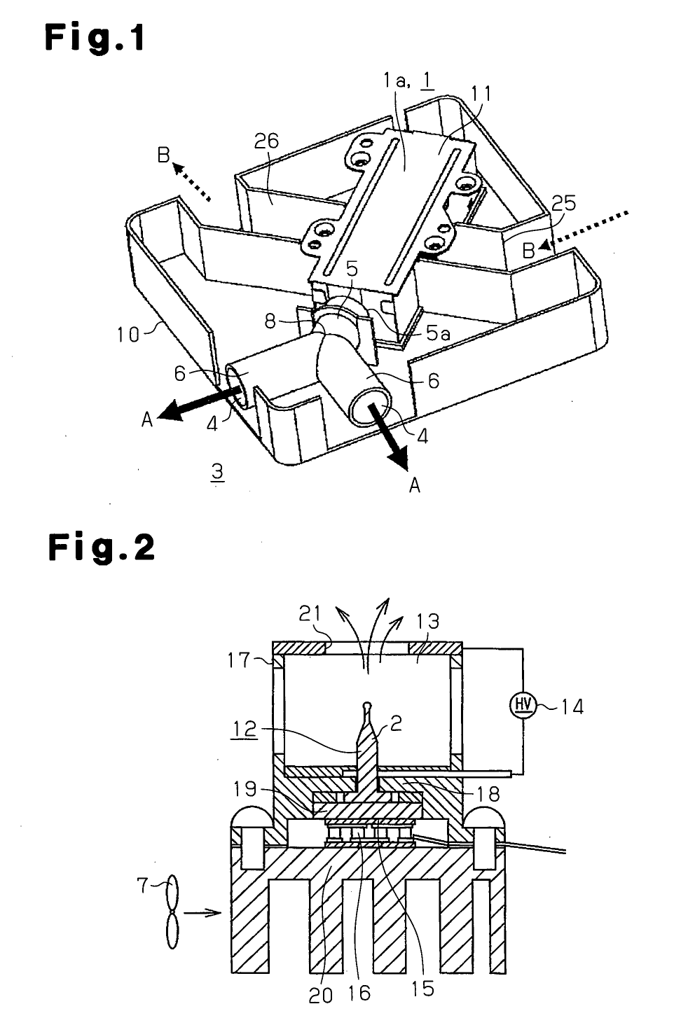

FIG. 1 shows an electrostatic atomization apparatus 1a, which is one example of a discharge apparatus 1. The electrostatic atomization apparatus 1a generates charged water microparticles of nanometer size by applying high voltage to water that is supplied to a discharge electrode 2. The application of the discharge apparatus 1 is not limited to the electrostatic atomization apparatus 1a. For example, the discharge apparatus 1 may also be applied to an ion generation apparatus that applies high voltage to the discharge electrode 2 to generate positively or negatively charged ions.

The electrostatic atomization apparatus 1a includes an apparatus housing 11, which is arranged in a shell casing 10. An electrostatic atomization module or unit 12 (refer to FIG. 2), which forms the main part of the electrostatic atomization apparatus 1a, is arranged in the apparatus housing 11. In the case of an ion generation apparatus, an ion generation module forming the main part of the ion generation apparatus is arranged in the apparatus housing 11.

The structure of the electrostatic atomization apparatus 1a, which is one example of the discharge apparatus 1, will now be discussed. FIG. 2 is a schematic diagram showing the electrostatic atomization module 12. The electrostatic atomization module 12 includes a discharge electrode 2, an electrostatic atomization chamber 13, a water supply unit 15, and a high voltage application unit 14. The discharge electrode 2 is arranged in the electrostatic atomization chamber 13. The water supply unit 15 supplies water to the distal end of the discharge electrode 2. The high voltage application unit 14 applies high voltage to the water supplied to the discharge electrode 2. As a result, the water undergoes electrostatic atomization that generates charged water microparticles.

In the embodiment shown in FIG. 2, the water supply unit 15 uses a cooling device such as a Peltier unit 16 to cool the moisture in the air and generate condensed water, which is supplied to the discharge electrode 2. Accordingly, in the present embodiment, the cooling device forms the water supply unit 15 that supplies water to the discharge electrode 2.

In the embodiment shown in FIG. 2, the electrostatic atomization module 12 includes a module casing 17, which is insulative and cylindrical. The module casing 17 includes a partition 18, which partitions the interior of the module casing 17. The Peltier unit 16 is arranged at one side of the partition 18 in the module casing 17. The other side of the partition 18 is used as the electrostatic atomization chamber 13.

The Peltier unit 16 includes, for example, two Peltier circuit boards and a plurality of bismuth telluride (BiTe) thermoelectric elements. Each Peltier circuit board includes an insulative plate and a circuit section formed on one side of the insulative plate. The insulative plate has high heat conductance and is formed from alumina or aluminum nitride. The thermoelectric elements are held between the two Peltier circuit boards, which are arranged facing toward each other, so that the circuit sections of the Peltier circuit boards electrically connect the thermoelectric elements. When the thermoelectric elements are supplied with power through a Peltier input lead wire, heat is conveyed from one Peltier circuit board to the other Peltier circuit board. The outer side of one Peltier circuit board is coupled to a cooling portion 19, and the outer side of the other Peltier circuit board is coupled to a heat radiation portion 20. In the embodiment of FIG. 2, heat radiation fins are shown as an example of the heat radiation portion 20.

The discharge electrode 2 has a basal portion connected to the cooling portion 19 of the Peltier unit 16. The discharge electrode 2 is inserted into a hole extending through the partition 18 of the module casing 17 and projects into the electrostatic atomization chamber 13.

In the embodiment shown in FIG. 2, the cylindrical module casing 17 has a distal open end. An annular opposing electrode 21 is arranged on the open end of the module casing 17. The opposing electrode 21 is not necessarily required.

As shown in FIG. 1, the electrostatic atomization apparatus 1a includes a discharge passage 5, which extends from the apparatus housing 11. The discharge passage 5 includes an upstream end 5a, which is in communication with an outlet of the electrostatic atomization chamber 13 and has a predetermined flow passage area, and two or more branching passages 6, which are located downstream of the upstream end 5a. In the embodiment of FIG. 1, a branching portion 8 is arranged in a middle part of the discharge passage 5, and two branching passages 6 are formed at the downstream side of the branching portion 8. The branching portion 8, or branching position, is not limited to one location in the discharge passage 5 and may be arranged at two or more locations.

Each branching passage 6 includes a downstream end serving as a discharge port 4. The discharge ports 4 of the branching passages 6 are each formed by an opening. The opening may have an area that is the same or different for each discharge port 4. In the embodiment of FIG. 1, the opening area of each discharge port 4 is set to be equal to or smaller than the flow passage area of the upstream end 5a. More preferably, the opening area of each discharge port 4 is set so that the opening area of every one of the discharge ports 4 totals to be greater than the flow passage area of the upstream end 5a. The charged water microparticles generated in the electrostatic atomization chamber 13 are discharged into the discharge target zone 3 through the discharge passage 5 from the discharge port 4 of each branching passage 6. The discharge ports 4 of the branching passages 6 open in different directions. In other words, the charged water microparticles are discharged in different directions.

The shell casing 10 includes an air inlet 25 and an air outlet 26. The air inlet 25 has one end, which is in communication with the exterior of the shell casing 10, and another end, which is in communication with an entrance arranged in a side wall of the apparatus housing 11. The air outlet 26 has one end, which is in communication with an exit arranged in a further side wall of the apparatus housing 11, and another end, which is in communication with the exterior of the shell casing 10.

A partition (not shown) divides the apparatus housing 11 into a region in which the cooling portion 19 of the Peltier unit 16 is located and a region in which the heat radiation portion 20 is located. The entrance and exit of the apparatus housing 11 describe above each open to the region in which the heat radiation portion 20 is located.

A blower 7 is arranged in the apparatus housing 11. When the blower 7 is driven, ambient air is drawn into the region in which the heat radiation portion 20 is located through the air inlet 25 and the entrance of the apparatus housing 11. The drawn in air cools the heat radiation portion 20 and then flows through the air outlet 26 and out of the exit of the apparatus housing 11.

The electrostatic atomization apparatus 1a is arranged in, for example, a ceiling, instrument panel, or door of a vehicle 27, such as an automobile, as shown in FIG. 6.

When the electrostatic atomization apparatus 1a is activated, the Peltier unit 16 is supplied with power thereby cooling the cooling portion 19. This, in turn, cools the discharge electrode 2 and condenses the moisture contained in the air. As a result, the distal end of the discharge electrode 2 is supplied with water (condensed water). In this state, high voltage is applied to the distal end of the discharge electrode 2, namely, the water on the distal end of the discharge electrode 2. This locally raises the liquid surface of the water into a cone that forms a Taylor cone. When the Taylor cone is formed, charges are concentrated at the distal part of the Taylor cone. This increases the electric field strength at the distal part and further grows the Taylor cone. As a result, the charges are concentrated at the distal part of the Taylor cone with high density, and the distal part of the Taylor cone receives a large energy amount (repulsive force of the high density charges). When the energy exceeds the surface tension, the water repetitively breaks up and disperses (Rayleigh breakup). This generates a large amount of water microparticles, which are negatively charged and have nanometer size.

The nanometer size charged water microparticles, which are generated through electrostatic atomization in the manner described above, are discharged through the discharge passage 5 out of the discharge port 4 of each branching passage 6 and into a discharge target zone 3 (i.e., into the passenger compartment).

Further, the nanometer size charged water microparticles discharged into the passenger compartment, which is the discharge target zone 3, float and collect on the walls, seats, dashboard, and curtains in the passenger compartment. The charged water microparticles also collect on the clothes, hair, and like of the passenger in the passenger compartment.

The nanometer size charged water microparticles (nano-mist) generated by atomizing water includes radicals such as superoxide radicals and hydroxy radicals. The radicals function to deodorize the inner walls, seats, dashboard, curtains, and clothes and hair of a passenger in the passenger compartment. The radicals also function to inactivate allergen substances such as pollen that may be carried into the passenger compartment when caught in the clothes of a passenger. Further, the radicals have antiseptic and sterilization effects. Moreover, the charged water microparticles are of a nanometer size and thus have a fine size. This allows the charged water microparticles to float to every corner of the passenger compartment and enter between fibers so as to perform sterilization, deodorization, antisepticising, allergen substance inactivation, and the like.

When high voltage is applied to the water supplied to the discharge electrode 2 in the electrostatic atomization apparatus 1a and nanometer size charged water microparticles are generated through electrostatic atomization, ozone is also generated. Accordingly, ozone is discharged together with the charged water microparticles into the passenger compartment, which is the discharge target zone 3.

The odor of ozone is strong near its origin of generation. To suppress the odor, the generated ozone is separated and discharged from the plurality of (two in the embodiment of FIG. 1) discharge ports 4 into the discharge target zone 3. This decreases the amount, or concentration, of the ozone discharged from each discharge port 4. Thus, the ozone odor would be unnoticed even in the vicinity of the discharge ports 4. Here, the concentration of the ozone discharged from the discharge passage of the described and illustrated embodiment and the concentration of the ozone discharged from the discharge passage of the prior art were compared using electrostatic atomization modules having the same capacity. The comparison results will now be described. When the discharge passage 5 is not branched and there is only one discharge part 4 like in the prior art structure, the concentration of the ozone discharged from the discharge port 4 was 0.3668 ppm. Thus, the ozone odor was unpleasant near the discharge port. In contrast, when the discharge passage 5 is branched into two like in the described and illustrated embodiment, the concentration of the ozone immediately after being discharged from one of the discharge ports 4 was 0.1668 pp, while the concentration of the ozone immediately after being discharged from the other one of the discharge ports 4 was 0.2022 ppm. Thus, the ozone odor was unnoticed in the vicinity of each of the discharge ports 4.

Accordingly, the ozone odor would be unnoticed by a passenger of the vehicle 27 even when the passenger's head is located near the electrostatic atomization apparatus 1a, which is installed in the ceiling, instrument panel, door, or the like of the vehicle 27, or when one of the discharge ports 4 is directed toward the passenger's head. The ozone discharged into the passenger compartment from the discharge ports 4 reacts with air as it floats into the passenger compartment. This decomposes the ozone.

In the embodiment shown in FIG. 1, the total opening area of the two discharge ports 4 is set to be greater than the flow passage area at the upstream end 5a of the discharge passage 5. Thus, the velocity of the current flowing through each branching passage 6 is lower than the velocity of the current flowing through upstream portion of the discharge passage 5. This lengthens the time in which ozone flows through the discharge passage 5 until it is discharged out of each discharge port 4. As a result, the ozone is in contact with air for a longer time and reacts with the air. This efficiently decreases the ozone concentration. Accordingly, the concentration of the ozone discharged into the discharge target zone 3 (passenger compartment) is further decreased, and the amount of ozone discharged from a single discharge ports 4 is also further decreased. Thus, the ozone odor in the vicinity of the discharge ports 4 becomes unnoticeable to a passenger. Further, in the example of FIG. 1, the two discharge ports 4 open in directions that are orthogonal to each other. This effectively disperses the discharged ozone.

It should be apparent to those skilled in the art that the present invention may be embodied in many other specific forms without departing from the spirit or scope of the invention. Particularly, it should be understood that the present invention may be embodied in the following forms.

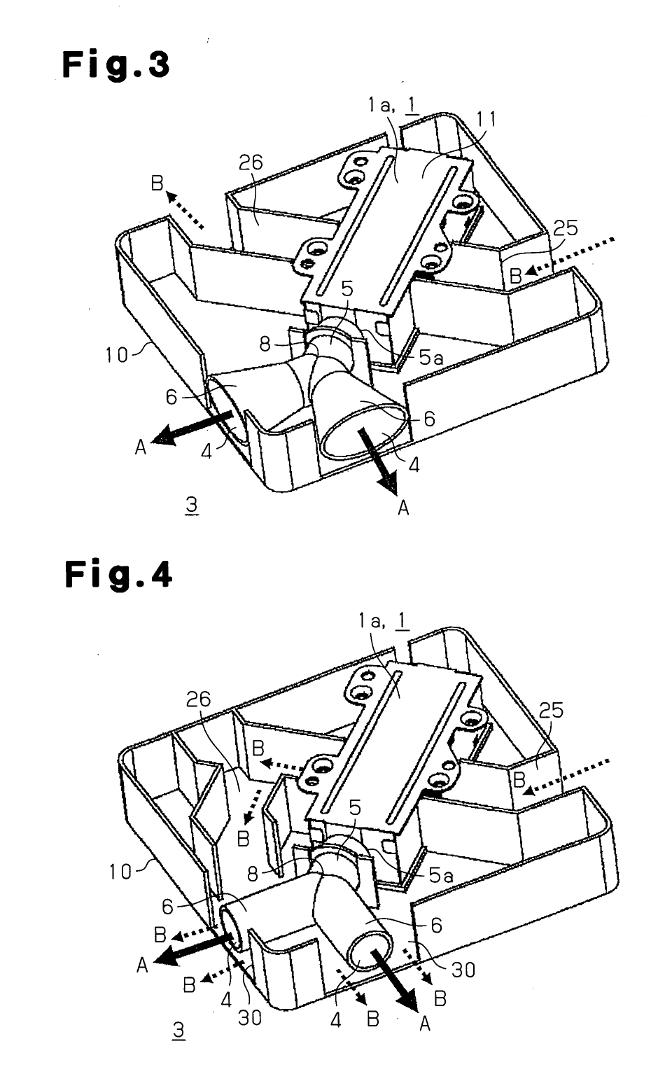

As shown in FIG. 3, the opening area of each discharge port 4 may be greater than the flow passage area at the upstream end 5a of the discharge passage 5. This further lowers the velocity of the current flowing through each branching passage 6, which, in turn, results in reaction of the ozone with air near the discharge port 4 that further decreases the ozone concentration.

The opening area of each discharge port 4 may be set independently from the flow passage area at the upstream end 5a of the discharge passage 5. In a structure including two or more (e.g., two in FIG. 3) branching passages 6, the discharging of ozone generated together with the charged water microparticles is dispersed by the branching passages 6 into the discharge target zone 3. Thus, in comparison to the prior art structure, the odor of ozone is suppressed regardless of the opening area of the discharge port 4 or the flow passage area at the upstream end 5a.

FIG. 4 shows a further structure of the air outlet 26 arranged in the shell casing 10. In the structure of FIG. 4, the air outlet 26 is the same as the structure shown in FIG. 1 in that one end is in communication with an exit arranged in a side wall of the apparatus housing 11 and a further end is in communication with the exterior of the shell casing 10. However, in FIG. 4, the further end of the air outlet 26 is in communication with a plurality of openings 30 arranged in the shell casing 10. The openings 30 are arranged adjacent to the discharge ports 4.

In the structure of FIG. 4, when the blower 7 is driven, ambient air is drawn through the air inlet 25 and the entrance of the apparatus housing 11 into the region in which the heat radiation portion 20 is located. The drawn in air cools the heat radiation portion 20. Then, the drawn in air flows from the exit of the apparatus housing 11 to the air outlet 26 and then from the openings 30 to the discharge target zone 3 (e.g., passenger compartment).

Accordingly, the charged water microparticles from each discharge port 4 are carried in the air current flowing out of each opening 30 and discharged into the discharge target zone 3. Thus, when ozone is discharged out of the discharge ports 4, the ozone mixes with the air flowing out of the openings 30. This efficiently lowers the concentration of the ozone and makes the ozone odor further unnoticeable.

In the example of FIG. 4, the current of air generated by the blower 7 cools the heat radiation portion 20 of the Peltier unit 16. Then, the air is discharged out of the openings 30, which are adjacent to the discharge ports 4. In addition to the blower 7, further blowers may be arranged near the air outlet 26 or the branching passages 6 (discharge ports 4). In this case, the currents of air generated by the blowers near the discharge ports 4 are mixed with the ozone discharged from the discharge ports 4. This further lowers the ozone concentration. In FIGS. 1 to 4, arrows A indicate the discharge directions of the charged water microparticles and ozone, and arrows B indicate the current of air produced by the blower 7 (and additional blowers). The structure of FIG. 4 may be applied to the embodiment shown in FIG. 3.

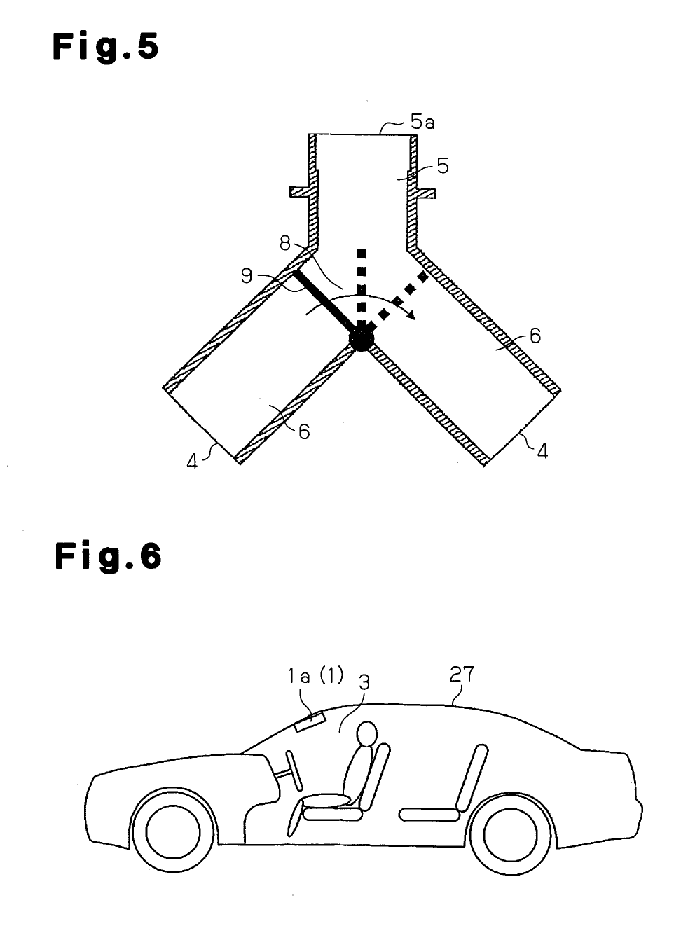

FIG. 5 shows a further embodiment. As shown in FIG. 5, the branching portion 8 of the discharge passage 5 includes a variable flow rate ratio unit 9, which varies the flow rate ratio between the branching passages 6.

The variable flow rate ratio unit 9 is formed by a movable valve (rotatable in the drawing). The variable flow rate ratio unit 9 moves the valve to switch the flow rate ratio between the branching passages 6 in the range of from 0% to 100%. For example, when the valve closes one of the two discharge ports 4, ozone is discharged only from the other discharge port 4 (and vice-versa). In this manner, the variable flow rate ratio unit 9 changes the discharge direction of ozone. Alternatively, the variable flow rate ratio unit 9 may discharge ozone from every one of the discharge ports 4 with the flow rate being greater in one of the discharge ports 4 than the other by moving the valve. In this manner, the variable flow rate ratio unit 9 can change the amount of ozone discharged from each discharge port 4 to decrease the amount of ozone discharged in the direction in which the ozone odor is noticeable. The variable flow rate ratio unit 9 is moved manually or automatically. The structure of the variable flow rate ratio unit 9 may be applied to the embodiment shown in FIG. 3.

In the above-described embodiments, the electrostatic atomization apparatus 1a serves as the discharge apparatus 1. However, the discharge apparatus 1 may be an ion generation apparatus.

In this case, high voltage is applied to a discharge electrode 2 of the ion generation apparatus to generate positive or negative ions. The ions are then discharged out of the branching passages 6 of the discharge passage 5 and into the discharge target zone 3. When the ions are generated, ozone is also generated at the same time. The generated ozone is separated and discharged from the branching passages 6. This decreases the amount of ozone discharged from each discharge port 4. Accordingly, the ozone odor is unnoticeable even in the vicinity of the discharge ports 4.

The electrostatic atomization apparatus 1a or ion generation apparatus serving as the discharge apparatus 1 in the embodiments described above are installed in the passenger compartment of the vehicle 27. However, in lieu of the vehicle 27, the discharge apparatus 1 may be arranged in any discharge target zone 3 such as the room of a building.

The present examples and embodiments are to be considered as illustrative and not restrictive, and the invention is not to be limited to the details given herein, but may be modified within the scope and equivalence of the appended claims.

1. A discharge apparatus comprising:
a discharge electrode used to generate charged water microparticles or ions; and
a discharge passage that discharges the charged water microparticles or ions into a discharge target zone, the discharge passage including:
an upstream end that draws in the charged water microparticles or ions; and
two or more branching passages, each located downstream of the upstream end and having a discharge port in communication with the discharge target zone.

2. The discharge apparatus according to claim 1, wherein the upstream end of the discharge passage has a predetermined flow passage area, and the discharge port of each of the branching passages has a predetermined opening area, with the opening area of all of the discharge ports totaling to be greater than the flow passage area of the upstream end.

3. The discharge apparatus according to claim 1, wherein the upstream end of the discharge passage has a predetermined flow passage area, and the discharge port of each of the branching passages has a predetermined opening area, with the opening area of each discharge port being greater than the flow passage area of the upstream end.

4. The discharge apparatus according to claim 1, wherein the discharge ports of the branching passages open in different directions.

5. The discharge apparatus according to claim 1, further comprising:
a blower that generates a current of air and discharges the charged water microparticles or ions with the current of air from the discharge ports into the discharge target zone.

6. The discharge apparatus according to claim 1, wherein the discharge passage includes a branching portion connecting the upstream end to the two or more branching passages, the discharge apparatus further comprising:
a variable flow rate ratio unit arranged in the branching portion to vary the ratio of the flow rate between the branching passages.
